(19) United States
(12) Patent Application Publication
(10) Pub. No.: US 2006/0017618 A1
(43) Pub. Date: Jan. 26, 2006

(54) Antenna structure

(76) Inventors: Hung-Wei Tseng, Tainan City (TW); Yueh-Lin Tsai, Shulin Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/063,775

(22) Filed: Feb. 24, 2005

(30) Foreign Application Priority Data
Jul. 9, 2004 (TW) 93210915

(51) Int. Cl. H01Q 1/38; H01Q 1/24

(52) U.S. Cl. 343/700 MS; 343/702

(57) ABSTRACT

An antenna module has a PCB with a plurality of contacts, a support element, and an antenna module. The support element has a support portion extended downwardly therefrom. The antenna module is connected with the support element. The antenna structure has a metal support element fixed on the PCB with a plurality of contacts. The support element is used to support an antenna module for electrically connecting the antenna module on the PCB with the contacts. When the antenna module connects to the PCB, the antenna contact does not project out the bottom side of the PCB. Therefore, the bottom side of the PCB is level. The antenna structure has a metal support used to shield the noise interference between the antenna module and the PCB.

### BACKGROUND OF THE INVENTION

1. Field of The Invention

The present invention relates to an antenna structure, and particularly relates to an antenna structure that has an antenna module supported by a metal support element and in which the antenna module contacts the PCB with a plurality of contacts.

2. Description of the Related Art

FIG. 1 shows a cross-sectional view of the antenna structure according to the prior art. The antenna structure includes a PCB 1a, and an antenna module 2a connected to the PCB 1a. The antenna module 2a has an antenna contact 20a inserted into and electrically connected to the PCB 1a. The antenna contact 20a has a bottom side 200a projected out the PCB 1a. A heatproof twin adhesive 3a attaches the antenna module 2a on the PCB 1a.

However, the prior art has some defects, as follows:

(1) The heatproof twin adhesive 3a attaches the antenna module 2a to the PCB 1a, so the antenna structure is not conveniently assembled;

(2) The heatproof twin adhesive 3a attaches the antenna module 2a to the PCB 1a, so it is not convenient to use the twin adhesive 3a. Therefore, the quality of the antenna structure is not stable, and the price of the antenna structure is not good;

(3) The bottom side 200a of the antenna contact 20a is projected out the PCB 1a, so the bottom side of the PCB 1a is not level; and

(4) Noise interference occurs between the antenna module 2a and the PCB 1a.

### SUMMARY OF THE INVENTION

The first objective of the present invention is to provide an antenna structure. The antenna structure has a metal support element fixed on the PCB with a plurality of contacts. The support element is used to support an antenna module for electrically connecting the antenna module on the PCB with the contacts.

The second objective of the present invention is to provide an antenna structure. When the antenna module connects to the PCB, the antenna contact does not project out the bottom side of the PCB. Therefore, the bottom side of the PCB is level.

The third objective of the present invention is to provide an antenna structure. The antenna structure has a metal support used to shield the noise interference between the antenna module and the PCB.

In order to achieve the above objects, the present invention provides an antenna module comprising a PCB with a plurality of contacts, a support element, and an antenna module.

The support element has a support portion extended downwardly therefrom, and the support element is fixed on the PCB by the support portion. The antenna module is connected with the support element, and has an antenna contact inserted into the PCB. It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawing, in which:

FIG. 1 is a cross-sectional view of the antenna structure of the prior art;

FIG. 2 is a perspective, exploded view of the antenna structure according to the first embodiment of the present invention;

FIG. 3 is a perspective, assembled view of the antenna structure according to the first embodiment of the present invention;

FIG. 4 a cross-sectional view of the antenna structure according to the first embodiment of the present invention;

FIG. 5 is another perspective, assembled view of the antenna structure according to the first embodiment of the present invention;

FIG. 6 is a perspective, exploded view of the antenna structure according to the second embodiment of the present invention;

FIG. 7 is a perspective, assembled view of the antenna structure according to the second embodiment of the present invention;

FIG. 8 is a perspective, exploded view of the antenna structure according to the third embodiment of the present invention; and

FIG. 9 is a perspective, assembled view of the antenna structure according to the third embodiment of the present invention.

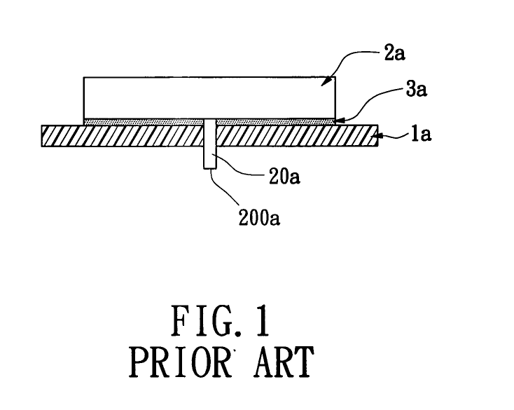

### DETAILED DESCRIPTION OF PREFERRED EMBODIMENTS

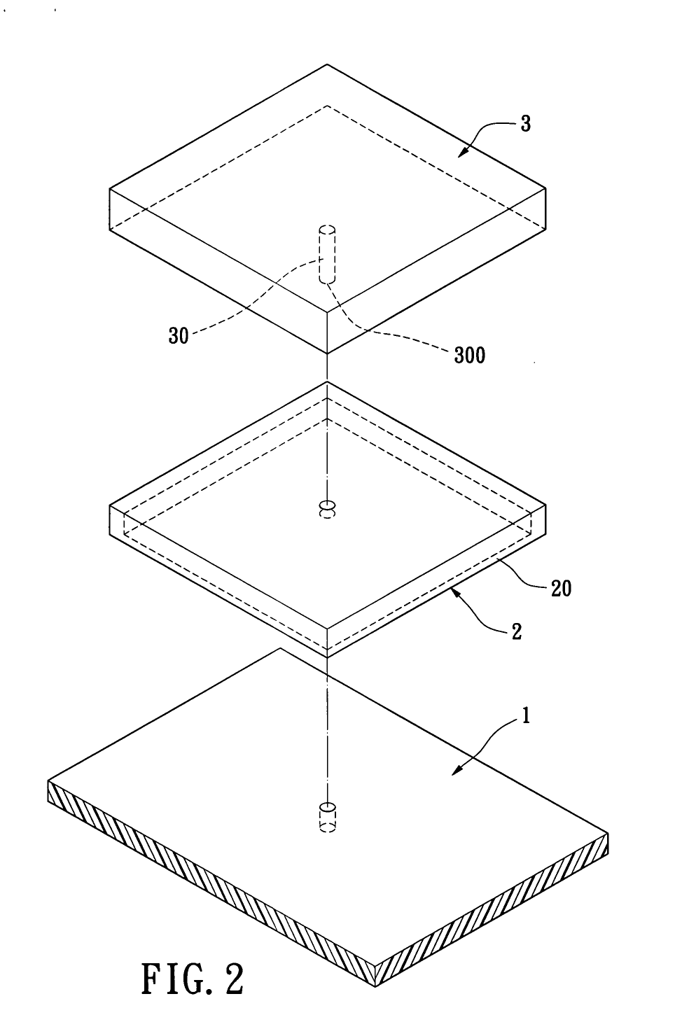

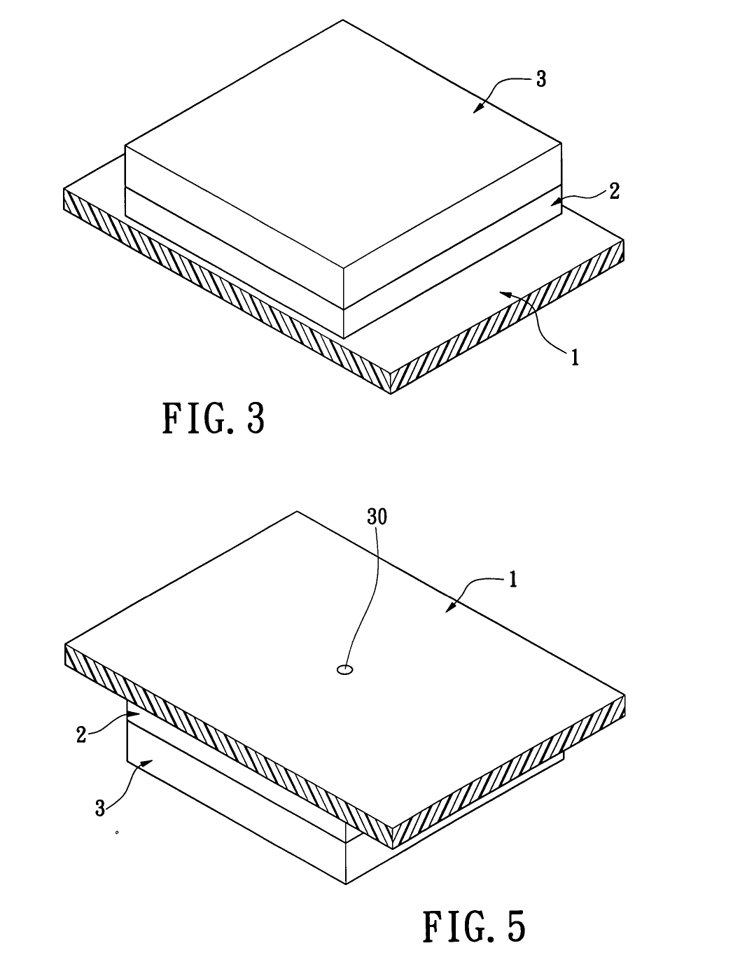

Referring to FIGS. 2 and 3, the first embodiment of the present invention provides an antenna structure including a PCB 1 with a plurality of contacts, a metal support element 2, and an antenna module 3.

The metal support element 2 is metal covered support, and has a support portion 20 formed therearound. The support portion 20 is fixed on the PCB 1 by SMT (Surface Mounted Technology) or inserted solder technology. The antenna module 3 is a GPS (Global Positioning System). The antenna module 3 is connected on the metal support element 2 by an adhesive body (not shown). The antenna module 3 has an antenna contact 30 inserted into the PCB 1. The adhesive body is a ceramics adhesive or a heatproof adhesive.

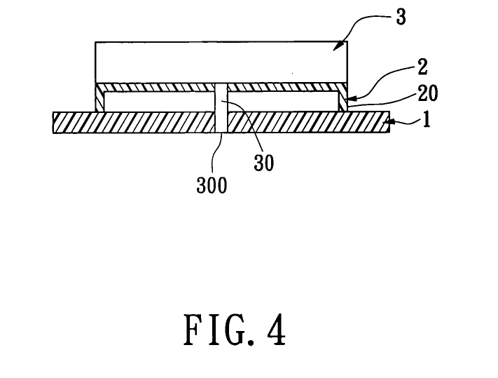

Referring to the FIGS. 4 and 5, the antenna contact 30 of the antenna module 3 has a bottom side 300. The metal support element 2 is used to support the antenna module 3 for the bottom side 300 to embed into the PCB 1. In other words, the antenna contact 30 of the antenna module 3 is electrically connected to the PCB 1, and does not project out from a bottom side of the PCB 1. Therefore, the bottom side of the PCB 1 is level.

The metal support element 2 is used to shield the noise interference between the PCB 1 and the antenna module 3 for increasing the security of the antenna module 3 in use.

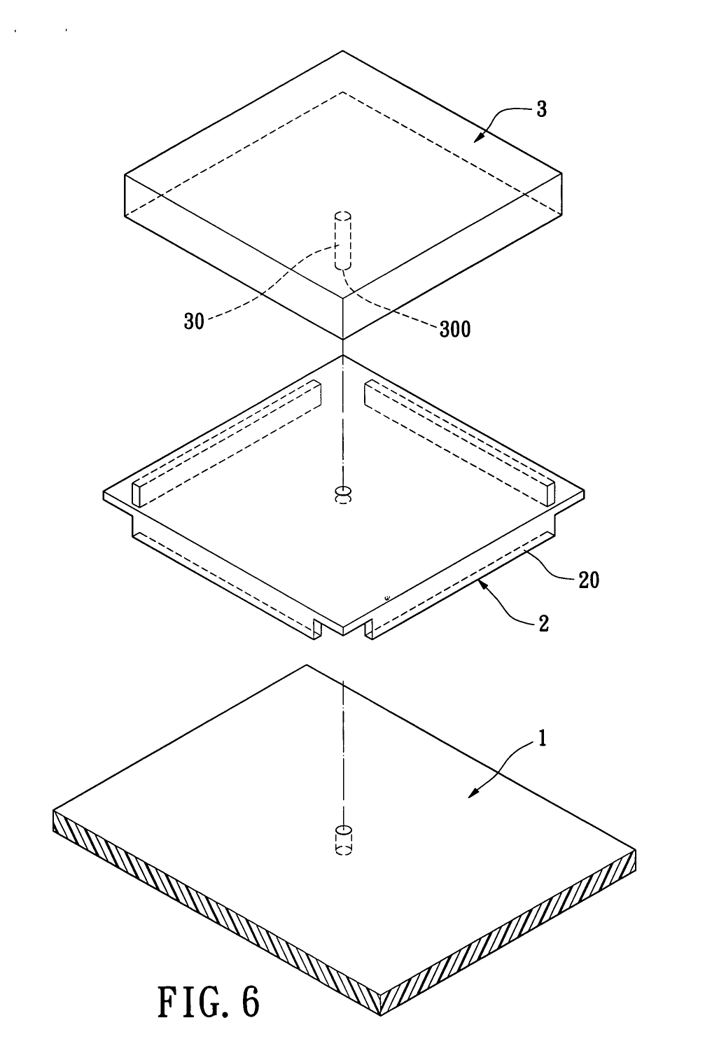

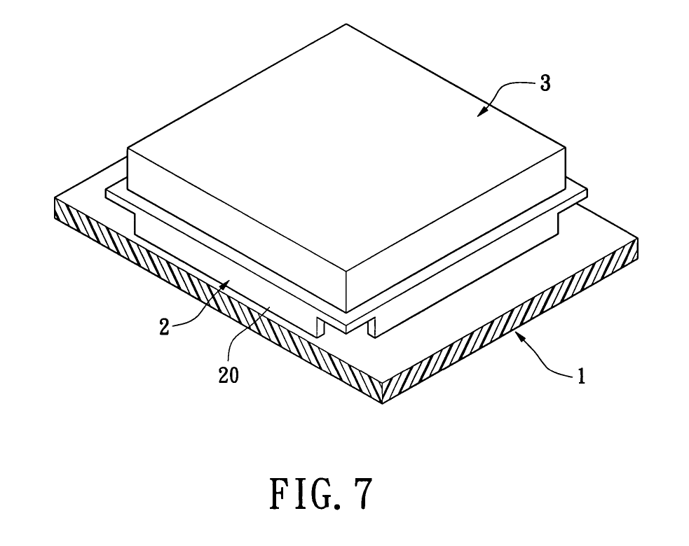

The FIGS. 6 and 7 show the second embodiment of the present invention. The support portion 20 of the metal support element 2 is a plurality of pins extended downwardly therefrom. The present invention does not limit the number of the pins and the distance between the two pins. The metal support element 2 has a contact surface smaller or larger than that of the antenna module 3. The metal support element 2 has different shapes according to the designer for the antenna module 3.

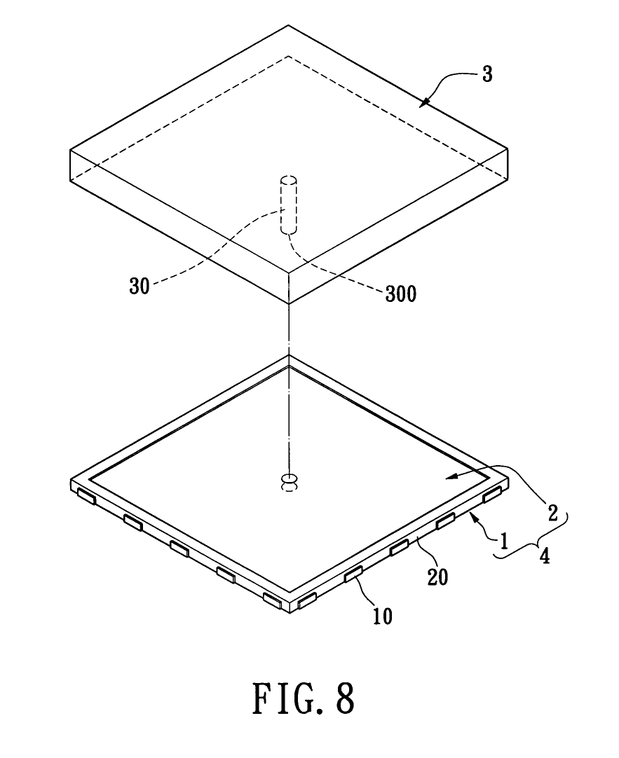

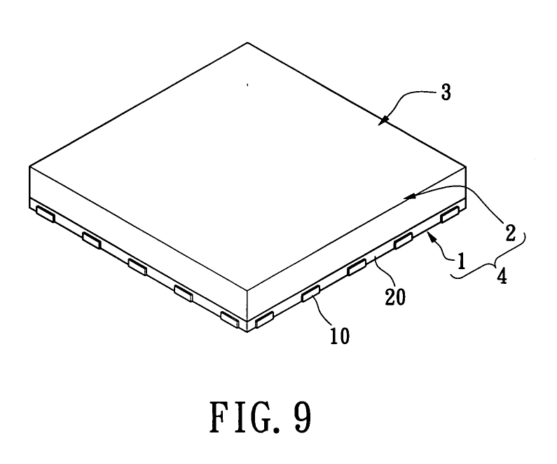

The FIGS. 8 and 9 show the third embodiment of the present invention. The PCB 1 has a plurality of pins 10 disposed on a bottom portion thereof.

The PCB 1 and the support element 2 are joined together to form a circuit module 4 by low-temperature cofired technology. The circuit module 4 and the antenna module 3 are assembled together to form an antenna module with a circuit function. The PCB 1 is fixed on the support portion 20 of the support element 2 by the pins 10. Moreover, the antenna structure is filled with good heat-conducting material between the PCB 1 and the support element 2.

To sum up, the antenna structure of the present invention includes some advantages, as follow:

(1) The support portion 20 of the support element 2 is fixed on the PCB 1 by SMT or inserted solder technology for increasing the convenience to assemble the antenna structure;

(2) When the antenna module 3 connects to the PCB 1, the antenna contact 30 of the antenna module 3 does not project out the bottom side of the PCB 1. Hence, the bottom side of the PCB 1 is level; and

(3) The support element 2 is arranged between the PCB 1 and the antenna module 3 for shielding the noise interference between the antenna module 3 and the PCB 1, and increasing the sensitivity of the antenna module 3 in use.

Although the present invention has been described with reference to the preferred embodiment thereof, it will be understood that the invention is not limited to the details thereof. Various substitutions and modification have suggested in the foregoing description, and other will occur to those of ordinary skill in the art. Therefore, all such substitutions and modifications are intended to be embraced within the scope of the invention as defined in the appended claims.

What is claimed is:

1. An antenna module, comprising:
a PCB with a plurality of contacts;
a support element having a support portion extended downwardly therefrom, and the support element being fixed on the PCB by the support portion; and
an antenna module connected with the support element, and having an antenna contact inserted into the PCB.

2. The antenna module as claimed in claim 1, wherein the support element is a metal support.

3. The antenna module as claimed in claim 1, wherein the support element is arranged between the PCB and the antenna module for shielding noise interference between the antenna module and the PCB.

4. The antenna module as claimed in claim 1, wherein the support element has a contact surface larger than that of the antenna module.

5. The antenna module as claimed in claim 1, wherein the support element has a contact surface smaller that that of the antenna module.

6. The antenna module as claimed in claim 1, wherein the support portion has a plurality of pins.

7. The antenna module as claimed in claim 1, wherein the support portion is fixed on the PCB by SMT (Surface Mounted Technology).

8. The antenna module as claimed in claim 1, wherein the support portion is fixed on the PCB by an inserted solder technology.

9. The antenna module as claimed in claim 1, wherein the antenna module is a GPS (Global Positioning System).

10. The antenna module as claimed in claim 1, wherein the antenna module is connected on the support element by an adhesive body.

11. The antenna module as claimed in claim 10, wherein the adhesive body is a ceramics adhesive or a heatproof adhesive.

12. The antenna module as claimed in claim 1, wherein the antenna contact of the antenna module has a bottom side embedded into the PCB.

13. The antenna module as claimed in claim 1, wherein the PCB has a plurality of pins disposed on a bottom portion thereof.

14. The antenna module as claimed in claim 1, wherein the PCB and the support element are jointed together to form a circuit module by low-temperature cofired technology, and the circuit module and the antenna module are assembled together to form the antenna module with a circuit function.
